(19) United States
(12) Patent Application Publication
(10) Pub. No.: US 2013/0004362 A1
(43) Pub. Date: Jan. 3, 2013

(54) PROCESS FOR PRODUCTION OF MEDICAL INSTRUMENT, AND MEDICAL INSTRUMENT

(75) Inventors: Ryoichi Soba, Kanagawa (JP); Hiraku Murayama, Shizuoka (JP); Kensuke Uemura, Kanagawa (JP)

(73) Assignees: NAGATA SEIKI KABUSHIKI KAISHA, Tokyo (JP); TERUMO KABUSHIKI KAISHA, Tokyo (JP)

(21) Appl. No.: 13/636,521

(22) PCT Filed: Mar. 10, 2011
(86) PCT No.: PCT/JP2011/055620

§ 371 Date: Sep. 21, 2012

(51) Int. Cl. B01J 19/12; C22C 14/00; C22C 19/03; C25F 3/16

(52) U.S. Cl. 420/417; 204/157.44; 205/640; 420/441

(57) ABSTRACT

A process for producing a medical instrument, such as a stent and a guide wire, which has an excellent fatigue life; and a medical instrument, such as a stent and a guide wire, which has an excellent fatigue life. The process for producing a medical instrument includes: a preparation step of preparing a medical instrument including a NiTi-based alloy as a base material; and an ion irradiation step of irradiating the medical instrument prepared in the preparation step with Xe ions. The medical instrument is produced by irradiating a medical instrument including a NiTi-based alloy as a base material with Xe ions.

### TECHNICAL FIELD

The present invention relates to a method of producing a medical instrument and a medical instrument.

### BACKGROUND ART

As base material of medical instruments such as stents and guide wires, there are known NiTi-based alloys, which are biocompatible shape-memory alloys (see Patent Document 1, paragraph [0028], and Patent Document 2, paragraph [0011]).

NiTi-based alloys denote a wide variety of alloys each including nickel and titanium as major components, typical examples thereof containing 43 wt % to 57 wt % of Ni, with the rest composed of Ti and incidental impurities. Some of these NiTi-based alloys are added with a trace amount of other metals such as cobalt, iron, palladium, platinum, boron, aluminum, silicon, vanadium, niobium, and copper.

Medical instruments such as stents and guide wires are required to exhibit some performances, on which various improvements are desired.

For example, Patent Document 1 describes a technique for modifying the surface of a polymer-coated stent by ion bombardment to provide antithrombogenicity. Ions that may be used for that purpose are exemplified by “He⁺, C⁺, N⁺, Ne⁺, Na⁺, N₂⁺, O₂⁺, Ar⁺, and Kr⁺” (see paragraph [0044]).

Patent Document 2 describes a technique for hardening the surface of a guide wire to reduce friction resistance by treating the metal wire with ion implantation before forming the metal wire into coils to produce a guide wire. Ions that may be used for that purpose are exemplified by “N, F, C, B, Ti, Ca, Ni, Co, Al, O, He, Ne, and P” (see paragraph [0024]).

### CITATION LIST

### Patent Document

Patent Document 1: JP 2003-325655 A
Patent Document 2: JP 9-182799 A

### SUMMARY OF INVENTION

### Technical Problems

The inventors of the present invention made a further study of medical instruments as described in Patent Documents 1 and 2 and found that the fatigue life so far achieved has yet to reach a level required today, and improvement needs to be made.

An object of the present invention therefore is to provide medical instruments such as stents and guide wires having an excellent fatigue life.

### Solution to Problems

The inventors of the present invention made an extensive study to solve the above problem and completed the present invention through the findings that medical instruments obtained through irradiation with Xe ions in manufacturing process have an excellent fatigue life.

Specifically, the invention provides the following (1) to (6).

(1) A method of producing a medical instrument comprising a preparation step for preparing a medical instrument whose base material is a NiTi-based alloy and an ion irradiation step for irradiating the prepared medical instrument with Xe ions.

(2) A method of producing a medical instrument according to (1) above, further comprising a polishing step for polishing a surface of the medical instrument prepared in the preparation step.

(3) A method of producing a medical instrument according to (1) or (2) above, wherein the polishing performed in the polishing step is polishing by electron irradiation and/or electrolytic polishing.

(4) A method of producing a medical instrument according to any one of (1) to (3) above, further comprising a heat-treating step for heat-treating the medical instrument prepared in the preparation step.

(5) A method of producing a medical instrument according to any one of (1) to (4) above, wherein the medical instrument prepared in the preparation step is a stent, a guide wire, an embolization coil, a vein filter, or an orthodontic wire.

(6) A medical instrument obtained by irradiating a medical instrument whose base material is a NiTi-based alloy with Xe ions.

### Advantageous Effects of Invention

The present invention makes it possible to obtain medical instruments such as stents and guide wires having an excellent fatigue life.

### BRIEF DESCRIPTION OF DRAWINGS

FIG. 1 is a front view illustrating a medical instrument of the invention as applied to a stent.

FIG. 2 is a graph illustrating the results of fatigue life evaluation.

FIG. 3 is a graph illustrating the results of fatigue life evaluation.

FIG. 4 is a graph illustrating the results of fatigue life evaluation.

### DESCRIPTION OF EMBODIMENTS

### Method of Producing a Medical Instrument

The method of producing a medical instrument according to the present invention comprises a preparation step for preparing a medical instrument whose base material is a NiTi-based alloy and an ion irradiation step for irradiating the medical instrument prepared in the preparation step with Xe ions.

The steps included in the method of producing a medical instrument according to the present invention are described in detail below.

### [Preparation Step]

The method of producing a medical instrument according to the present invention comprises a preparation step for preparing a medical instrument whose base material is a NiTi-based alloy. The preparation step may be performed by following a normal procedure used to fabricate a medical instrument whose base material is a NiTi-based alloy.

Where the medical instrument is a stent, for example, the non-stent component of a pipe made of a NiTi-based alloy is removed (the removal is achieved by, for example, cutting or dissolution) to obtain a stent configuration, additionally performing, where necessary, higher-temperature shape-memory treatment and lower-temperature shape-memory treatment known in the art.

Other medical instruments are also fabricated and prepared by a known production method.

The preparation step is performed before the ion irradiation described later. Thus, where the medical instrument is a stent, for example, the ion irradiation applied to the non-stent component can be dispensed with, which also eliminates the risk of removing the layer of the stent component with the effect of the ion irradiation when removing the non-stent component.

Medical instruments prepared in the preparation step are not specifically limited and may be exemplified by a stent, a guide wire, an embolization coil, a vein filter, and an orthodontic wire.

The NiTi-based alloy constituting the base material of the medical instrument prepared in the preparation step denotes a wide variety of alloys each containing nickel and titanium as major components. Some of the NiTi-based alloys are generally called shape memory alloys and exhibit superelasticity at least at biological temperature (ca. 37° C.). The superelasticity herein denotes an elasticity whereby a metal, when, after being deformed (bent, pulled, or compressed) at a service temperature to an extent such that a normal metal would undergo a plastic deformation, freed from a stress causing such deformation, almost restores the original shape without requiring to be heated.

A typical example of the NiTi-based alloy contains 43 wt %, to 57 wt % of Ni, with the rest composed of Ti and incidental impurities. Some of these NiTi-based alloys are added with a trace amount of other metals such as cobalt, iron, palladium, platinum, boron, aluminum, silicon, vanadium, niobium, and copper.

The NiTi-based alloy constituting the base material of the medical instrument prepared in the preparation step preferably contains 54.5 wt % to 57 wt % of Ni, with the rest composed of Ti and incidental impurities. Such NiTi-based alloys may contain, in addition to Ti and Ni, 0.070 wt % or less of C, 0.050 wt % or less of Co, 0.010 wt % or less of Cu, 0.010 wt % or less of Cr, 0.005 wt % or less of H, 0.050 wt % or less of Fe, 0.025 wt % or less of Nb, and 0.050 wt % or less of O.

### [Ion Irradiation Step]

The method of producing a medical instrument according to the invention comprises an ion irradiation step for irradiating the medical instrument prepared in the preparation step with Xe ions. Inclusion of the ion irradiation step helps improve the fatigue life of the obtained medical instrument. This may be explained by the increase in dislocation density of the NiTi-based alloy occurring as the Xe ions, which are heavier than, for example, Ar ions, are allowed to hit the NiTi-based alloy, the base material.

Although the conditions for the Xe ion irradiation in the ion irradiation step are not specifically limited, an ion implanter I-I type (manufactured by Nagata Seiki Co., Ltd.), for example, may be preferably used for ion irradiation.

The Xe gas pressure is preferably 0.004 Pa to 0.008 Pa. The Penning current is preferably 1.2 A to 1.6 A. The acceleration voltage is preferably 10 kV to 30 kV. The acceleration current is preferably 35 mA to 50 mA. The dose of irradiation is preferably 10¹⁶ ions/cm² to 10¹⁸ ions/cm².

The Xe ion irradiation performed within the above ranges further increases the fatigue life of the obtained medical instrument.

### [Acid Treatment Step]

The method of producing a medical instrument according to the invention may comprise an acid treatment step for acid-treating the medical instrument prepared in the preparation step.

In some cases, the NiTi-based alloy constituting part of the medical instrument may contain inclusions occurring in the manufacture of the alloy. Furthermore, in the above preparation step, foreign matter may attach to the surface of the medical instrument, which may be, for example, a stent or a guide wire. Therefore, the outermost layer of the surface of the medical instrument that may contain inclusions or foreign matter is removed in the acid treatment step.

The acid used for the acid treatment may be any acid, provided that it dissolves the NiTi-based alloy, and may be exemplified by nitric acid, hydrofluoric acid, hydrogen peroxide, and a mixed acid thereof. Among them, a mixed acid of nitric acid and hydrofluoric acid is particularly preferred because the mixed acid exhibits a strong dissolution effect for the NiTi-based alloy.

Any of appropriate etching solutions on the market may also be used as an acid for the acid treatment, an example thereof being the FE-17 Fuji Aceclean (manufactured by Fuji Acetylene Ind. Co., Ltd.).

The acid treatment may be performed by any method as appropriate, including, for example, spraying and immersion, particularly preferred being acid treatment by immersion because an acid can be allowed to appropriately contact the surface of the medical instrument such as stent having a fine and intricate configuration.

The place of the acid treatment in the sequence of the treatments performed in the method of the invention is not specifically limited but the acid treatment is preferably performed after the preparation step and before the ion irradiation step.

### [Polishing Step]

The method of producing a medical instrument according to the present invention preferably comprises a polishing step for polishing the surface of the medical instrument in order to smoothen the surface of the medical instrument prepared in the preparation step (e.g., a stent from which the non-stent components have been removed).

In the polishing step, the surface of the medical instrument prepared in the preparation step is preferably finished to a surface roughness Ra of 1.5 μm or less, more preferably 0.32 μm or less, and still more preferably 0.15 μm or less.

The polishing performed in the polishing step is preferably polishing by electron irradiation and/or electrolytic polishing.

(Polishing by Electron Irradiation)

The polishing by electron irradiation preferably satisfies, for example, the following conditions.

Energy density: about 1 J/cm² or more, preferably about 1 J/cm² or more and about 20 J/cm² or less, more preferably about 2 J/cm² or more and about 15 J/cm² or less, still more preferably about 4 J/cm² or more and about 12 J/cm² or less, and most preferably about 5 J/cm² or more and about 9 J/cm² or less.

Pulse width: 1 μs or more

Number of times irradiation is applied (number of pulses): about 5 times or more, more preferably about 20 to 40 times.

(Electrolytic Polishing)

The electrolytic polishing preferably satisfies, for example, the following conditions.

Electrolytic solution: a mixed liquid of sulfuric acid, phosphoric acid, and water

Voltage: 15 V

The place of the polishing step in the sequence of the steps followed in the method of the invention is not specifically limited but the polishing step is preferably performed after the acid treatment step and before the ion irradiation step.

Where both polishing by electron irradiation and electrolytic polishing are performed as polishing in the polishing step, polishing by electron irradiation and electrolytic polishing may be performed in any order.

The polishing by electron irradiation may reduce the fatigue life in some cases as described later but is easy to perform as compared with the electrolytic polishing whereby the disposal of the electrolytic solution is complicated. Therefore, polishing by electron irradiation followed by Xe ion irradiation is advantageous, enabling easy and uniform polishing and increased fatigue life.

### [Heat Treatment Step]

The method of producing a medical instrument according to the present invention preferably further comprises a heat treatment step to obtain further improved fatigue life. The heat treatment step is a step for heat-treating the medical instrument prepared in the preparation step.

The heat treatment in the heat treatment step is preferably an annealing treatment. The annealing treatment may be performed in a vacuum or in an atmosphere of noble gas such as, for example, argon or helium, at a temperature of 300° C. to 1100° C., preferably 450° C. to 700° C., and more preferably 500° C. to 600° C., for 1 minute to 10 hours, preferably five minutes to one hour, and more preferably five minutes to 30 minutes.

The place of the heat treatment step in the sequence of the steps followed in the method of the invention is not specifically limited, but the heat treatment step is preferably performed after the polishing step and before the ion irradiation step.

### [Other Steps]

The method of producing a medical instrument according to the present invention may further comprise other steps as necessary such as, for example, a step for forming a layer containing a biological physiologically active substance such as, for example, immune suppressor and carcinostatic on the surface of the medical instrument and a surface modifying step including, for example, hydrophilization treatment and resin coating treatment. These additional steps are performed after the ion irradiation step.

### <Medical Instrument>

The medical instrument of the invention is a medical instrument obtained by irradiating a medical instrument whose base material is a NiTi-based alloy with Xe ions. The “medical instrument whose base material is a NiTi-based alloy” denotes a medical instrument prepared in the preparation step.

The medical instrument of the invention may be a medical instrument having undergone acid treatment in the acid treatment step, polishing in the polishing step, and heat treatment in the heat treatment step.

Therefore, the medical instrument of the invention is substantially a medical instrument obtained by the method of producing a medical instrument according to the present invention.

Hereinbelow, the medical instrument of the invention and a medical instrument obtained by the method of producing a medical instrument according to the present invention are both called also “the medical instrument of the invention.” The medical instrument of the invention is exemplified by a stent, a guide wire, an embolization coil, a vein filter, and an orthodontic wire.

Examples where the invention related to a medical instrument is applied to a stent will now be described.

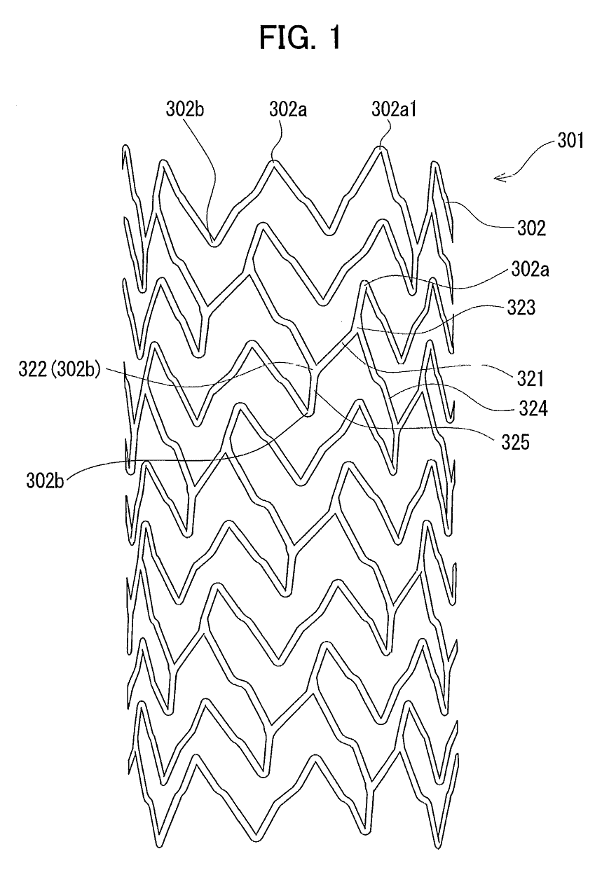

FIG. 1 is a front view illustrating a medical instrument of the invention as applied to a stent. A stent 301 illustrated in FIG. 1 has a substantially cylindrical shape. The stent 301, which is reduced in diameter when inserted into the body and restores its pre-contraction shape when retained in the body, is a so-called self-expanding stent. FIG. 1 illustrates the external appearance of the stent 301 as expanded.

The size of the stent 301 is not specifically limited and varies depending on the site where it is retained. The outer diameter thereof as expanded is preferably in a range of 2.0 mm to 30 mm and more preferably in a range of 2.5 mm to 20 mm. Its length is preferably in a range of 5 mm to 250 mm and more preferably in a range of 15 mm to 200 mm.

In particular, where the stent 301 is of a type retained in a blood vessel, the outer diameter thereof is preferably in a range of 2.0 mm to 14 mm and more preferably in a range of 2.5 mm to 12 mm. Its length is then preferably in a range of 5 mm to 100 mm and more preferably in a range of 10 mm to 80 mm.

Its wall thickness is preferably in a range of 0.04 mm to 0.3 mm and more preferably in a range of 0.06 mm to 0.22 mm.

The stent 301 having a substantially cylindrical shape comprises a plurality of undulating rings 302 in the axial direction. The number of undulating rings 302 is preferably 2 to 150 and more preferably 5 to 100, though it depends on, among others, the length of the stent 301.

The undulating rings 302 are composed of endless, annularly continuous undulating elements. The undulating elements constituting the undulating rings 302 are composed mostly of curved lines and have few straight segments. Thus, the undulating elements constituting the undulating rings 302 are sufficiently long to exhibit a high expandability at the time of expansion. The axial length of each undulating ring 302 is preferably 1 mm to 10 mm and more preferably 1.5 mm to 5 mm.

Each undulating ring 302 comprises bends on one side thereof in the axial direction of the stent 301 including apices 302a and bends on the other side in the axial direction of the stent 301 including apices 302b.

The bends on one side and on the other side alternate with each other and are provided in an equal number. The number of the bends on one side (or the bends on the other side) of one undulating ring 302 is preferably 4 to 20 and more preferably 6 to 12.

The apices 302a intrude on the spaces formed between the apices 302b of a neighboring undulating ring 302, and the apices 302b intrude on the spaces formed between the apices 302a of another neighboring undulating ring 302.

The undulating rings 302 have shared linear segments 321.

Each shared linear segment 321 has its starting end 322 at or near an apex 302b and its terminal end 323 between an apex 302b and an apex 302a. Neighboring undulating rings 302 are united by the shared linear segments 321.

The undulating rings 302 further comprise short linear segments 325 and long linear segments 324.

Each short linear segment 325 connects between the starting end 322 of a shared linear segment 321 and an apex 302b of the bends on the other side. The short linear segments 325 are not continuous in the axial direction of the stent 301 and provided so as to be aligned substantially rectilinearly.

Each long linear segment 324 connects between the terminal end 323 of a shared linear segment 321 and another apex 302b of the bends on the other side. The length of the long linear segment 324 is slightly longer than the combined length of the shared linear segment 321 and the short linear segment 325.

The configuration of the stent 301 is described in detail in Japanese Patent Application No. 2008-238215.

Even after placement in vasculature where the stent is subject to significant deformation, as in the legs, the stent 301 having the above configuration is not broken by significant deformation. In addition, the stent, irradiated with Xe ions in the manufacturing process, excels in fatigue life.

While examples where the present invention related to a medical instrument is applied to a stent are described above, the invention is not limited thereto.

For example, where the invention is applied to a guide wire comprising an elongated core member and a coil-shaped member enveloping the whole or part of the core member, the base material of the core member and the coil-shaped member is the NiTi-based alloy described above. Because the core member and the coil-shaped member are irradiated with Xe ions after shaping, the obtained guide wire excels in fatigue life.

Such guide wire preferably has a bending strength of 600 N/mm² or more and more preferably 800 N/mm² to 1100 N/mm².

### EXAMPLES

The present invention is described in detail below with reference to Examples, which by no means limit the scope of the present invention.

In the reference examples, comparative examples, and working examples described below, wires made of NiTi-based alloy (Ti: 49 at % (43.94 wt %), Ni: 51 at % (56.06 wt %)) (having a diameter of 0.5 mm) cut into a length of 20 cm (referred to as “sample wire” below) were subjected to the following treatments. The treatments and the order in which they were performed are shown in Table 2.

### [Acid Treatment]

A sample wire was immersed for 30 seconds at room temperature in a solution prepared by diluting Fuji Aceclean FE-17 (HNO₃:53.8%, HF:8.0%, H₂O:38.2%) with water to a concentration of 25 vol %.

### [Polishing by Electron Irradiation]

The sample wire was subjected to electron irradiation under the following conditions.

Anode voltage: 20 kV

Energy density: about 7 J/cm²

Distance between electron gun tip and sample wire: 20 mm

Number of pulses: 10 shots

Electron irradiation was applied to three places in the sample wire at intervals of 35 mm in the longitudinal direction thereof. The sample wire was then turned over for irradiation applied likewise on the rear side thereof.

### [Electrolytic Polishing]

A mixed liquid of sulfuric acid, phosphoric acid, and water was used as electrolytic solution in electrolytic polishing performed at a voltage of 15 V.

### [Heat Treatment]

The annealing was performed in the heat treatment in a vacuum (pressure: 8×10⁻³ Pa) at 650° C. for one hour, followed by ice quenching.

### [Ion Irradiation]

Ion irradiation was performed using the above ion implanter I-I type (manufactured by Nagata Seiki Co., Ltd.) under conditions given in Table 1 below (ions used for the irradiation: Xe ions).

TABLE 1

| | Pennig | Acceleration | Acceleration | |
|---|---|---|---|---|
| Pressure | Current | Voltage | Current | Dose |
| [Pa] | [A] | [kV] | [mA] | [ions/cm²] |
| 0.005 Xe | 1.5 | 10-30 | 35-50 | 5 × 10¹⁷ |

### [Fatigue Life Evaluation]

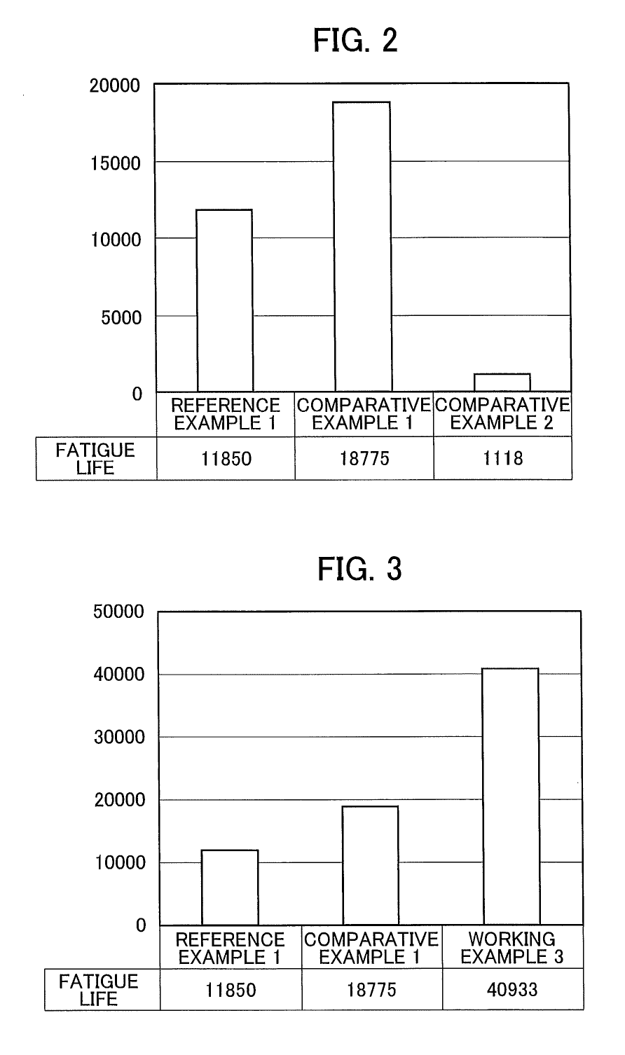

The sample wire having undergone the above treatments was subjected to a rotary bending test under the following conditions to evaluate the fatigue life (number of cycles). The result is given in Table 2 and FIGS. 2 to 4.

Temperature of the bath in which the wire was immersed: 37° C.

Rotation speed: 3600 rpm

In a 3-point bending test conducted under the following conditions, the center distance in the rotary bending test was adjusted among samples so that an equal level of stress was applied in the rotary bending test.

(3-Point Bending Test)

Test speed: 2 mm/min

Fulcrum distance: 25 mm

Indentation amount: 0 mm→2.5 mm→0 mm

TABLE 2

| | Reference | Comparative | | | | |
|---|---|---|---|---|---|---|
| | Example | Example | | Working Example | | |
| | 1 | 1 | 2 | 1 | 2 | 3 |
| Treatment | Untreated | [Acid | [Acid | [Acid | [Acid | [Acid |
| | | Treatment] | Treatment] | Treatment] | Treatment] | Treatment] |
| | | ↓ | ↓ | ↓ | ↓ | ↓ |
| | | [Electrolytic | [Polishing by | [Polishing by | [Electrolytic | [Electrolytic |
| | | Polishing] | Electron | Electron | Polishing] | Polishing] |
| | | | Irradiation] | Irradiation] | ↓ | ↓ |
| | | | | ↓ | [Polishing by | [Heat |
| | | | | [Heat | Electron | Treatment] |
| | | | | Treatment] | Irradiation] | ↓ |
| | | | | ↓ | ↓ | [Ion |
| | | | | [Ion | [Heat | Irradiation] |
| | | | | Irradiation] | Treatment] | |
| | | | | | ↓ | |
| | | | | | [Ion | |
| | | | | | Irradiation] | |
| Fatigue | 11850 | 18775 | 1118 | 19594 | 35059 | 40933 |
| Life | | | | | | |

The graph in FIG. 2 shows how electrolytic polishing or polishing by electron irradiation changed the fatigue life.

As is apparent from the graph in FIG. 2, a sample wire subjected to polishing by electron irradiation (Comparative Example 2) had a significantly reduced fatigue life as compared with an untreated sample wire (Reference Example 1).

The graph in FIG. 3 compares the fatigue lives of sample wires subjected to electrolytic polishing.

As is apparent from FIG. 3, a sample wire subjected to electrolytic polishing followed by Xe ion irradiation (Working Example 3) had a significantly improved fatigue life as compared with a sample wire not subjected to Xe ion irradiation (Comparative Example 1).

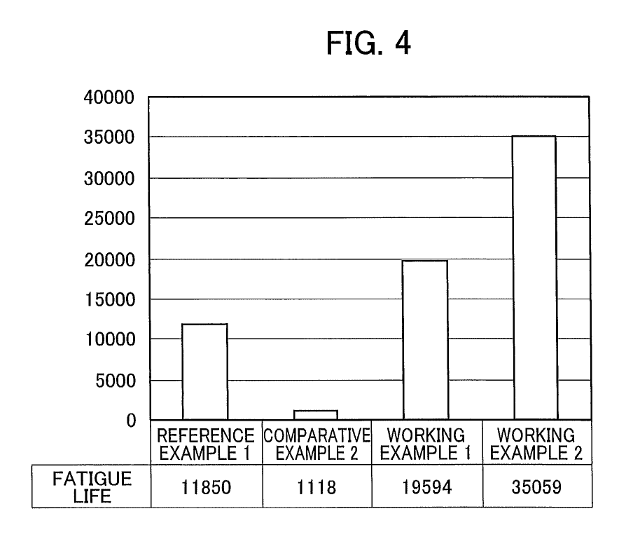

The graph in FIG. 4 compares the fatigue lives of sample wires subjected to polishing by electron irradiation.

While, as described above, the sample wire subjected to polishing by electron irradiation (Comparative Example 2) had a significantly reduced fatigue life, a sample wire subjected to polishing by electron irradiation followed by Xe ion irradiation (Working Example 1) had a significantly improved fatigue life as compared with an untreated sample wire (Reference Example 1) as is apparent from the graph in FIG. 4. Further, it was found that a sample wire that was subjected to electrolytic polishing prior to polishing by electron irradiation and thereafter (after the polishing by electron irradiation) underwent Xe ion irradiation (Working Example 2) excelled in fatigue life.

### DESCRIPTION OF SYMBOLS

301 Stent
302 Undulating rings
302a Apex
302b Apex
321 Shared linear segment
322 Starting end
323 Terminal end
324 Long linear segment
325 Short linear segment

1. A method of producing a medical instrument, comprising:
a preparation step for preparing a medical instrument whose base material is a NiTi-based alloy; and
an ion irradiation step for irradiating the medical instrument prepared in the preparation step with Xe ions.

2. A method of producing a medical instrument according to claim 1, further comprising:
a polishing step for polishing a surface of the medical instrument prepared in the preparation step.

3. A method of producing a medical instrument according to claim 1,
wherein the polishing performed in the polishing step is polishing by electron irradiation and/or electrolytic polishing.

4. A method of producing a medical instrument according to claim 1, further comprising:
a heat-treating step for heat-treating the medical instrument prepared in the preparation step.

5. A method of producing a medical instrument according to claim 1,
wherein the medical instrument prepared in the preparation step is a stent, a guide wire, an embolization coil, a vein filter, or an orthodontic wire.

6. A medical instrument obtained by irradiating a medical instrument whose base material is a NiTi-based alloy with Xe ions.

7. A method of producing a medical instrument according to claim 2,
wherein the polishing performed in the polishing step is polishing by electron irradiation and/or electrolytic polishing.

8. A method of producing a medical instrument according to claim 2,
further comprising a heat-treating step for heat-treating the medical instrument prepared in the preparation step.

9. A method of producing a medical instrument according to claim 3, further comprising:
a heat-treating step for heat-treating the medical instrument prepared in the preparation step.

10. A method of producing a medical instrument according to claim 7, further comprising:
a heat-treating step for heat-treating the medical instrument prepared in the preparation step.

11. A method of producing a medical instrument according to claim 2,
wherein the medical instrument prepared in the preparation step is a stent, a guide wire, an embolization coil, a vein filter, or an orthodontic wire.

12. A method of producing a medical instrument according to claim 3,
wherein the medical instrument prepared in the preparation step is a stent, a guide wire, an embolization coil, a vein filter, or an orthodontic wire.

13. A method of producing a medical instrument according to claim 4,
wherein the medical instrument prepared in the preparation step is a stent, a guide wire, an embolization coil, a vein filter, or an orthodontic wire.

14. A method of producing a medical instrument according to claim 7,
wherein the medical instrument prepared in the preparation step is a stent, a guide wire, an embolization coil, a vein filter, or an orthodontic wire.

15. A method of producing a medical instrument according to claim 8,
wherein the medical instrument prepared in the preparation step is a stent, a guide wire, an embolization coil, a vein filter, or an orthodontic wire.

16. A method of producing a medical instrument according to claim 9,
wherein the medical instrument prepared in the preparation step is a stent, a guide wire, an embolization coil, a vein filter, or an orthodontic wire.

17. A method of producing a medical instrument according to claim 10,
wherein the medical instrument prepared in the preparation step is a stent, a guide wire, an embolization coil, a vein filter, or an orthodontic wire.
